(19) United States
(12) Patent Application Publication
(10) Pub. No.: US 2021/0179795 A1
(43) Pub. Date: Jun. 17, 2021

(54) HARD COAT COMPOSITION, HARD COAT-EQUIPPED POLYIMIDE FILM, METHOD FOR MANUFACTURING THE SAME, AND IMAGE DISPLAY DEVICE

(71) Applicant: KANEKA CORPORATION, Osaka (JP)

(72) Inventors: Rika Mori, Osaka (JP); Satoko Komatsu, Osaka (JP)

(73) Assignee: KANEKA CORPORATION, Osaka (JP)

(21) Appl. No.: 17/183,728

(22) Filed: Feb. 24, 2021

Related U.S. Application Data
(63) Continuation of application No. PCT/JP2019/032669, filed on Aug. 21, 2019.

(30) Foreign Application Priority Data
Aug. 24, 2018 (JP) 2018-157848

(51) Int. Cl. C08J 7/046; C08G 73/10; C08J 7/04; B05D 3/06; C08L 79/08; C08K 9/10

(52) U.S. Cl. CPC C08J 7/046; C08G 73/1067; C08J 7/0427; B82Y 30/00; C08L 79/08; C08K 9/10; B05D 3/067

(57) ABSTRACT

A hard coat-equipped polyimide film has a hard coat layer (2) on a principal surface of a transparent polyimide film (1). A hard coat composition for polyimide film contains a siloxane compound having an alicyclic epoxy group. The hard coat composition may contain fine particles. The hard coat-equipped polyimide fin is obtained by coating the hard coat composition on a principal surface of a transparent polyimide film and curing the hard coat composition by applying an active energy ray.

### TECHNICAL FIELD

One or more embodiments of the present invention relate to a hard coat composition which is used for forming a hard coat layer on a principal surface of a transparent polyimide film. One or more embodiments of the present invention also relate to a hard coat-equipped polyimide film, a method for manufacturing the same, and an image display device.

### BACKGROUND

With rapid progress of electronic devices such as displays, touch panels and solar cells, it has been required to make devices thinner, lighter and flexible. In response to these demands, an attempt has been made to replace glass materials, which are used for substrates, cover windows, etc., with plastic film materials. In these applications, plastic films are required to have high heat resistance, dimensional stability at a high temperature, and high mechanical strength. In recent years, curved displays and foldable displays (flexible displays) have been developed, and plastic films are required to have flex resistance in addition to the above-described characteristics.

In Patent Document 1, a hard coat film having a hard coat layer on a surface of a polyethylene terephthalate film is disclosed as a transparent substrate material for flexible displays. By providing a hard coat layer on a surface of a base film, mechanical strength such as surface hardness and scratch resistance can be improved.

When a plastic material is required to have heat resistance and dimensional stability at a high temperature, a polyimide film is used. A general-purpose fully aromatic polyimide is colored yellow or brown. A transparent polyimide having a high visible light transmittance can be obtained by introduction of alicyclic structure, bent structure, fluorine substituent, etc. Patent Document 2 indicates that by forming a radically polymerizable or cationically polymerizable hard coat layer on a surface of a transparent polyimide film, a decrease in surface hardness is suppressed while a flex resistance is improved.

### PATENT DOCUMENTS

Patent Document 1: Japanese Patent Laid-Open No. 2015-69197
Patent Document 2: Japanese Patent Laid-Open No. 2018-28073

In order to appropriately protect a display panel and the like, a transparent film material to be used for a flexible display is required to be comparable in surface hardness to glass. However, there is generally a trade-off relationship between the flex resistance and the surface hardness of a resin film, and the flex resistance tends to decrease as the surface hardness is increased.

Materials with higher hardness have been developed as hard coat materials for displays, which are provided on a surface of a polarizing plate or the like. However, since the adhesion of the hard coat material varies depending on the type of the base film, it is possible to have both high adhesion to a polyimide film and high surface hardness, and a hard coat material excellent in flex resistance is required.

The present inventors have extensively conducted studies in view of the above-described circumstances, and resultantly found that by forming a hard coat layer on a polyimide film with the use of a photocationically polymerizable hard coat composition containing a specific siloxane compound, a hard coat-equipped polyimide film, which satisfies the above-described characteristics, can be obtained.

### SUMMARY

One or more embodiments of the present invention relate to a hard coat-equipped polyimide film, which has a hard coat layer on a principal surface of a transparent polyimide film. Further, one or more embodiments of the present invention relate to a hard coat composition for polyimide film, which is used for preparing a hard coat-equipped polyimide film.

The hard coat composition for polyimide film contains a siloxane compound having an alicyclic epoxy group. The weight average molecular weight of the siloxane compound may be 500 to 20000. The hard coat composition may be a photocationically polymerizable composition containing a photocationic polymerization initiator. The siloxane compound may be a condensate of a silane compound containing a compound of the following general formula (I).

Y—R¹—(Si(OR²)ₓR³₃₋ₓ) (1)

In formula (I), Y is an alicyclic epoxy group; R¹ is an alkylene group with 1 to 10 carbon atoms; R² is a hydrogen atom or an alkyl group having 1 to 10 carbon atoms; R³ is a hydrogen atom, or a monovalent hydrocarbon group selected from an alkyl group having 1 to 10 carbon atoms, an aryl group having 6 to 25 carbon atoms, and an aralkyl group having 7 to 12 carbon atoms; and x is an integer of 1 to 3.

The hard coat composition may further contain fine particles. The average particle diameter of the fine particles may be 5 to 1000 nm.

The fine particles may be metal oxide fine particles or polymer fine particles. The metal oxide fine particles may be silica particles. The polymer fine particles may be core-shell polymer particles including a rubber polymer core layer and a shell layer provided on the surface of the core layer.

The fine particle contained in the hard coat composition may have on the surface thereof a polymerizable functional group capable of reacting with the alicyclic epoxy group of the siloxane compound. Among the polymerizable functional groups capable of reacting with the alicyclic epoxy group, an epoxy group is preferable.

The hard coat-equipped polyimide film has on a principal surface of a transparent polyimide film a hard coat layer formed of a cured product of the hard coat composition. A hard coat-equipped polyimide film can be obtained by applying the hard coat composition onto the principal surface of the transparent polyimide film and irradiating the hard coat composition with an active energy ray to cure the hard coat composition.

The total light transmittance of the hard coat-equipped polyimide film may be 80% or more. The thickness of the hard coat layer may be 1 to 50 μm. It is preferable that the hard coat layer is disposed so as to contact the polyimide film.

The polyimide resin constituting the transparent polyimide film has an acid dianhydride-derived structure and a diamine-derived structure. In one embodiment, the polyimide resin contains at least one selected from the group consisting of an alicyclic acid dianhydride and a fluorine-containing aromatic acid dianhydride as the acid dianhydride, and a fluorine-containing diamine as the diamine. Examples of the polyimide resin include polyimides containing 10 to 65 mol % of a bis-anhydrous trimellitic acid ester and 30 to 80 mol % of fluorine-containing aromatic acid dianhydride based on 100 mol % of the total amount of acid dianhydrides, and 40 mol % or more of fluoroalkyl-substituted benzidine based on 100 mol % of the total amount of diamines; and polyimides containing a total of 70 mol % or more of an alicyclic acid dianhydride and a fluorine-containing aromatic acid dianhydride as acid dianhydrides based on 100 mol % of the total amount of acid dianhydrides, and a total of 70 mol % or more of fluoroalkyl-substituted benzidine and 3,3′-diaminodiphenylsulfone as diamines based on 100 mol % of the total amount of diamines.

The hard coat composition of one or more embodiments of the present invention exhibits high adhesion specifically to a transparent polyimide film, and can attain both hardness and flex resistance. Thus, the hard coat film of one or more embodiments of the present invention can also be applied to a cover window material of a flexible display, etc.

### BRIEF DESCRIPTION OF THE DRAWINGS

FIG. 1 is a sectional view showing a configuration of a hard coat-equipped polyimide film.

FIG. 1 is a cross-sectional view of a hard coat-equipped polyimide film 10 (hereinafter, sometimes referred to simply as a “hard coat film”) in which a hard coat layer 2 is disposed on one principal surface of a polyimide film 1. A hard coat composition is applied to the principal surface of the polyimide film 1 as a base film, and cured to form a hard coat layer 2.

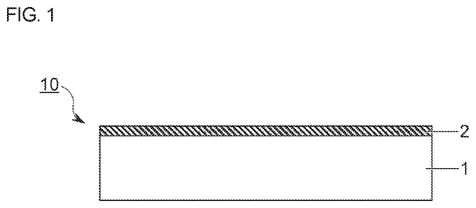

The hard coat layer may be disposed on only one principal surface of the polyimide film, or may be disposed on both surfaces of the polyimide film. The hard coat layer 2 may be formed on the entire principal surface of the polyimide film 1, or may be formed on only a part of the principal surface.

### DETAILED DESCRIPTION OF THE EMBODIMENTS

Hereinafter, preferred embodiments of the polyimide film and the hard coat composition for forming a hard coat layer will be described. Unless otherwise specified, one of the components, functional groups, etc. described in the present description may be used alone, or two or more thereof may be used in combination (coexistence).

[Polyimide Film]

The polyimide film 1 is a transparent film having a total light transmittance of 80% or more. The total light transmittance of the polyimide film may be 85% or more, 88% or more, or 90% or more. The haze of the polyimide film may be 2% or less, 1% or less. The haze of the polyimide film may be 0.1% or more, or 0.2% or more.

It is preferable that the polyimide film to be used for display devices, etc. has a small absolute value of yellowness index (YI). The absolute value of yellowness index (YI) of the polyimide film may be 3.5 or less, 3.0 or less. The light transmittance of the polyimide film at a wavelength of 400 m may be 55% or more, 60% or more, 65% or more, or 70% or more.

From the viewpoint of heat resistance, the glass transition temperature of the polyimide film may be 200° C. or higher, 250° C. or higher, or 300° C. or higher. The glass transition temperature is a temperature at which the loss tangent has a maximum in dynamic mechanical analysis (DMA). If the glass transition temperature is excessively high, formation processing may become difficult. Therefore, the glass transition temperature of the polyimide film may be 500° C. or lower.

<Composition of Polyimide Resin>

The polyimide film contains a polyimide resin. In general, a polyimide resin is obtained by dehydrocyclization of polyamic acid obtained by condensation of a tetracarboxylic acid dianhydride (hereinafter, sometimes referred to simply as an “acid dianhydride”) and a diamine. In other words, the polyimide has an acid dianhydride-derived structure and a diamine-derived structure. It is preferable that the transparent polyimide resin contains an alicyclic structure or a fluorine atom in at least one of the acid dianhydride and the diamine. It is more preferable that the transparent polyimide resin contains an alicyclic structure or a fluorine atom in both the acid dianhydride and the diamine.

The weight average molecular weight of the polyimide may be 5,000 to 500,000, 10,000 to 300,000, or 30,000 to 200,000. When the weight average molecular weight is within this range, sufficient mechanical properties and processability can be easily attained. The molecular weight in the present description is a value calculated in terms of polyethylene oxide (PEO), which is obtained by gel permeation chromatography (GPC). The molecular weight can be adjusted by the molar ratio of a diamine and an acid dianhydride, reaction conditions, etc.

(Acid Dianhydride)

For obtaining a polyimide film having high transparency and less colored, it is preferable that the polyimide contains an alicyclic acid dianhydride and/or a fluorine-containing aromatic dianhydride as acid dianhydride components.

Examples of alicyclic acid dianhydride include 1,2,3,4-cyclobutanetetracarboxylic acid dianhydride, 1,2,3,4-cyclopentanetetracarboxylic acid dianhydride, 1,2,4,5-cyclohexanetetracarboxylic acid dianhydride, 1,1′-bicyclohexane-3,3′,4,4′-tetracarboxylic acid dianhydride-3,4,3′,4′-dianhydride. In particular, the acid anhydride may be 1,2,3,4-cyclobutanetetracarboxylic dianhydride and/or 1,2,4,5-cyclohexanetetracarboxylic dianhydride, or 1,2,3,4-cyclobutanetetracarboxylic dianhydride, because a polyimide excellent in transparency and mechanical strength can be obtained.

Examples of fluorine-containing aromatic dianhydride include 2,2-bis(3,4-dicarboxyphenyl)-1,1,1,3,3,3-hexafluoropropanoic acid dianhydride, 2,2-bis(2,3-dicarboxyphenyl)-1,1,1,3,3,3-hexafluoropropane dianhydride, and 2,2-bis{4-[4-(1,2-dicarboxyphenyl)phenoxy]phenyl}-1,1,1,3,3,3-hexafluoropropane dianhydride. Among them, 2,2-bis(3,4-dicarboxyphenyl)-1,1,1,3,3,3-hexafluoropropanoic acid dianhydride is preferable. The solubility of the polyimide resin in a solvent tends to be enhanced by using a fluorine-containing aromatic acid anhydride as an acid dianhydride component. When the polyimide resin has solubility in a solvent, adhesion between the polyimide film and the hard coat layer may be improved because the surface of the polyimide film is slightly swelled by a solvent and a monomer in the composition in application of the hard coat composition.

The polyimide resin may contain components other than the alicyclic acid dianhydride and the fluorine-containing aromatic acid dianhydride as acid dianhydride components. Examples of the acid dianhydrides other than the alicyclic acid dianhydride and the fluorine-containing aromatic acid dianhydride include aromatic tetracarboxylic dianhydrides in which four carbonyl groups are bonded to one aromatic ring, such as pyromellitic acid dianhydrides, 1,2,5,6-naphthalenetetracarboxylic acid dianhydrides and 2,3,6,7-naphthalene tetracarboxylic dianhydride; and aromatic tetracarboxylic dianhydrides in which two carbonyl groups are bonded to each of different aromatic rings, such as 2,2-bis[4-(3,4-dicarboxyphenoxy)phenyl]propane dianhydride, 2,2-bis[4-(3,4-dicarboxyphenoxy)phenyl] hexafluoropropane dianhydride, 2,2-bis(4-hydroxyphenyl)propanedibenzoate-3,3′,4,4′-tetracarboxylic dianhydride, 3,3′,4,4′-biphenyltetracarboxylic dianhydride, 2,3,3′,4′-biphenyltetracarboxylic dianhydride, 4,4′-(hexafluoroisopropylidene)diphthalic anhydride, 3,3′,4,4′-benzophenonetetracarboxylic dianhydride, 3,4′-oxydiphthalic anhydride, 4,4′-oxydiphthalic anhydride, 3,3′,4,4′-diphenylsulfonetetracarboxylic dianhydride and bis-trimellitic anhydride ester.

The above-described bis-trimellitic anhydride ester is an ester of trimellitic anhydride and a diol. The diol may be an aromatic diol. Examples of the aromatic diol include hydroquinones, biphenols and bisphenols. Examples of the bis-trimellitic anhydride aromatic ester include compounds of the following general formula (1).

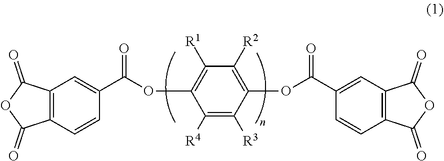

In general formula (1), n is an irregular of 1 or more, and substituents R¹ to R⁴ are each independently a hydrogen atom, fluorine atom, an alkyl group having 1 to 20 carbon atoms, or a perfluoroalkyl group having 1 to 20 carbon atoms. When n is 2 or more, the substituents R¹ to R⁴ bonded to benzene rings may be the same or different.

Specific examples of the alkyl group include a methyl group, an ethyl group, an n-propyl group, an isopropyl group, an n-butyl group, an isobutyl group, a t-butyl group, a cyclobutyl group, an n-pentyl group, an isopentyl group, a neopentyl group, a cyclopentyl group, an n-hexyl group and a cyclohexyl group. Specific examples of the perfluoroalkyl group include a trifluoromethyl group.

In general formula (1), n may be 1 or 2, and R¹ to R⁴ may each independently be a hydrogen atom, a methyl group or a trifluoromethyl group. Specific examples of acid dianhydrides with n=2 in the general formula (1), i.e. bis-trimellitic anhydride esters having a biphenyl backbone, include p-biphenylene-bis(trimellitic dianhydride) (abbreviation: BP-TME), 3,3′-dimethyl-biphenylene-bis(trimellitic dianhydride) (abbreviation: OCBP-TME), and bis(1,3-dioxo-1,3-dihydroisobenzofuran-5-carboxylic acid)-2,2′,3,3′,5,5′-hexamethylbiphenyl-4,4′-diyl (also referred to as 2,2′,3,3′,5,5′-hexamethyl-biphenyl-bis(trimellitic dianhydride) (abbreviation: TAHMBP)) of the following formula (2). Examples of the acid dianhydride with n=1 in general formula (1) include p-phenylene bis(trimellitic anhydride) (TMHQ) represented by formula (3) below.

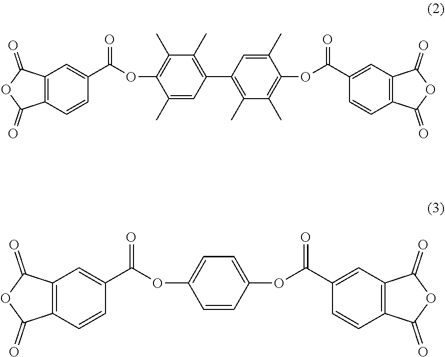

A polyimide containing a bis-trimellitic anhydride ester in addition to a fluorine-containing aromatic acid dihydride as acid dianhydride tends to have high solubility in a low-boiling-point alkyl halide such as dichloromethane, and a polyimide film formed therefrom tends to have high transparency and mechanical strength.

(Diamine)

It is preferable that the transparent polyimide contains a fluorine-containing aromatic diamine as a diamine component.

Examples of the fluorine-containing aromatic diamine include fluoroalkyl-substituted benzidines in which some or all of the hydrogen atoms of the biphenyl of 4,4′-diaminobiphenyl (benzidine) are substituted with fluoroalkyl groups; and fluorine-substituted benzidines in which some or all of the hydrogen atoms of biphenyl of benzidine are substituted with fluorine atoms. Specific examples of the fluorine-containing aromatic diamine of 1,4-diamino-2-fluorobenzene, 1,4-diamino-2,3-difluorobenzene, 1,4-diamino-2,5-difluorobenzene, 1,4-diamino-2,6-difluorobenzene, 1,4-diamino-2,3,5-trifluorobenzene, 1,4-diamino, 2,3,5,6-tetrafluorobenzene, 1,4-diamino-2-(trifluoromethyl)benzene, 1,4-diamino-2,3-bis(trifluoromethyl)benzene, 1,4-diamino-2,5-bis(trifluoromethyl)benzene, 1,4-diamino-2,6-bis(trifluoromethyl)benzene, 1,4-diamino-2,3,5-tris(trifluoromethyl)benzene and 1,4-diamino-2,3,5,6-tetrakis(trifluoromethyl)benzene, 2-fluorobenzidine, 3-fluorobenzidine, 2,3-difluorobenzidine, 2,5-difluorobenzidine, 2,6-difluorobenzidine, 2,3,5-trifluorobenzidine, 2,3,6-trifluorobenzidine, 2,3,5,6-tetrafluorobenzidine, 2,2′-difluorobenzidine, 3,3′-difluorobenzidine, 2,3′-difluorobenzidine, 2,2′,3-trifluorobenzidine, 2,3,3′-trifluorobenzidine, 2,2′,5-trifluorobenzidine, 2,2′,6-trifluorobenzidine, 2,3′,5-trifluorobenzidine, 2,3′,6,-trifluorobenzidine, 2,2′,3,3′-tetrafluorobenzidine, 2,2′,5,5′-tetrafluorobenzidine, 2,2′,6,6′-tetrafluorobenzidine, 2,2′,3,3′,6,6′-hexafluorobenzidine, 2,2′,3,3′,5,5′,6,6′-octafluorobenzidine, 2-(trifluoromethyl)benzidine, 3-(trifluoromethyl)benzidine, 2,3-bis(trifluoromethyl)benzidine, 2,5-bis(trifluoromethyl)benzidine, 2,6-bis(trifluoromethyl)benzidine, 2,3,5-tris(trifluoromethyl)benzidine, 2,3,6-tris(trifluoromethyl)benzidine, 2,3,5,6-tetrakis(trifluoro)methyl)benzidine, 2,2′-bis(trifluoromethyl)benzidine, 3,3′-bis(trifluoromethyl)benzidine, 2,3′-bis(trifluoromethyl)benzidine, 2,2′,3-bis(trifluoromethyl) benzidine, 2,3,3′-tris(trifluoromethyl)benzidine, 2,2′,5-tris(trifluoromethyl)benzidine, 2,2′,6-tris(trifluoromethyl))benzidine, 2,3′,5-tris(trifluoromethyl)benzidine, 2,3′,6,-tris (trifluoromethyl)benzidine, 2,2′,3,3′-tetrakis(trifluoromethyl)benzidine, 2,2′,5,5′-tetrakis(trifluoromethyl)benzidine, and 2,2′,6,6′-tetrakis(trifluoromethyl)benzidine. The fluorine-containing aromatic diamine may be a fluoroalkyl-substituted benzidine from the viewpoint of obtaining polyimide excellent in transparency and mechanical strength. Among them, bis(trifluoromethyl)benzidines such as 2,2′-bis(trifluoromethyl)benzidine and 3,3′-bis(trifluoromethyl)benzidine are preferable, and 2,2′-bis(trifluoromethyl)benzidine is particularly preferable.

The mechanical strength of the polyimide resin tends to be improved by using a sulfonyl group-containing diamine in addition to the fluorine-containing aromatic diamine as the diamine component. Examples of the sulfonyl group-containing diamine include diphenylsulfone derivatives such as 3,3′-diaminodiphenylsulfone, 3,4′-diaminodiphenylsulfone, 4,4′-diaminodiphenylsulfone, bis[4-(3-aminophenoxy)phenyl]sulfone, bis[4-(4-aminophenoxy)phenyl]sulfone, 4,4′-bis[4-(4-amino-α,α-dimethylbenzyl)phenoxy]diphenylsulfone, and 4,4′-bis[4-(4-(aminophenoxy)phenoxy)diphenylsulfone. Among them, 3,3′-diaminodiphenylsulfone (3,3′-DDS) or 4,4′-diaminodiphenylsulfone (4,4′-DDS) is preferable, and 3,3′-DDS is particularly preferable, because mechanical strength can be improved without impairing the transparency of the polyimide resin.

The polyimide resin may contain components other than the fluorine-containing aromatic diamine and the sulfonyl group-containing diamine as diamine components. Examples of the diamine other than the fluorine-containing aromatic diamine and the sulfonyl group-containing diamine include diamines in which two amino groups are bonded to one aromatic ring, such as p-phenylenediamine, m-phenylenediamine and o-phenylenediamine; aromatic diamines in which an amino group is bonded to each of different aromatic rings, such as diaminodiphenyl ether, diaminodiphenyl sulfide, diaminobenzophenone, diaminodiphenylalkanes and bis(aminobenzoyl)benzene; and alicyclic diamines such as diaminocyclohexane and isophoronediamine.

(Specific Example of Composition of Polyimide 1)

In one embodiment, the polyimide resin contains an alicyclic acid dianhydride and a fluorine-containing aromatic acid anhydride as acid dianhydrides, and a fluorine-containing diamine and a sulfonyl group-containing diamine as diamines.

From the viewpoint of the transparency of the polyimide resin, the total amount of the alicyclic acid dianhydride and the fluorine-containing aromatic acid dianhydride may be 70 mol % or more based on 100 mol % of the total amount of acid dianhydride components. The total amount of the alicyclic acid dianhydride and the fluorine-containing aromatic acid dianhydride based on 100 mol % of the total amount of acid dianhydride components can be 75 mol % or more, 80 mol % or more, 85 mol % or more, 90 mol % or more, or 95 mol % or more. When an aromatic tetracarboxylic dianhydride in which two carbonyl groups are bonded to each of different aromatic rings is used in addition to the alicyclic acid dianhydride and/or the fluorine-containing aromatic acid dianhydride, as an acid dianhydride component, it may be possible to improve the heat resistance and the mechanical strength without impairing the transparency of the polyimide resin.

From the viewpoint of attaining both the transparency and the mechanical strength and flex resistance of the polyimide resin, the content of the alicyclic acid dianhydride may be 20 to 95 mol % based on 100 mol % of the total amount of acid dianhydride components. The amount of the alicyclic acid dianhydride based on 100 mol % of the total amount of acid dianhydride components can be 25 mol % or more, 30 mol % or more, 35 mol % or more, 40 mol % or more, 45 mol % or more, or 50 mol % or more. The amount of the alicyclic acid dianhydride based on 100 mol % of the total amount of acid dianhydride components can be 90 mol % or less, 85 mol % or less, 80 mol % or less, 75 mol % or less, 70 mol % or less, or 65 mol % or less. The content of 1,2,3,4-cyclobutanetetracarboxylic dianhydride may be in the above-described range because a polyimide resin excellent in transparency and mechanical strength and excellent in flex resistance and adhesion with the hard coat layer can be obtained.

From the viewpoint of the transparency and the flex resistance of the polyimide resin, the content of the fluorine-containing aromatic acid dianhydride based on 100 mol % of the total amount of acid dianhydride components can be 5 mol % or more, 10 mol % or more, 15 mol % or more, 20 mol % or more, or 25 mol % or more. The content of 2,2-bis(3,4-dicarboxyphenyl)-1,1,1,3,3,3-hexafluoropropane dianhydride may be in the above-described range because a polyimide resin excellent in transparency can be obtained.

From the viewpoint of the transparency of the polyimide resin, the content of the fluorine-containing aromatic diamine based on 100 mol % of the total amount of diamine components can be 25 mol % or more, 30 mol % or more, 35 mol % or more, 40 mol % or more, 45 mol % or more, 50 mol % or more, 55 mol % or more, or 60 mol % or more. The content of 2,2′-bis(trifluoromethyl)benzidine may be in the above-described range because a polyimide resin excellent in transparency can be obtained.

From the viewpoint of improving the transparency and the mechanical strength of the polyimide resin, the content of the sulfonyl group-containing diamine may be 10 to 75 mol % based on 100 mol % of the total amount of diamine components of the polyimide. The content of the sulfonyl group-containing diamine based on 100 mol % of the total amount of diamine components of the polyimide can be 15 mol % or more, 20 mol % or more, or 25 mol % or more. The content of the sulfonyl group-containing diamine based on 100 mol % of the total amount of diamine components of the polyimide is 70 mol % or less, 65 mol % or less, 60 mol % or less, 55 mol % or less, 50 mol % or less, 45 mol % or less, 40 mol % or less or 35 mol % or less. In particular, the content of 3,3′-DDS may be in the above-described range.

From the viewpoint of transparency of the polyimide resin, the total amount of the fluorine-containing aromatic diamine and the sulfonyl group-containing diamine may be 70 mol % or more based on 100 mol % of the total amount of diamine components. The total amount of the fluorine-containing aromatic diamine and the sulfonyl group-containing diamine based on 100 mol % of the total amount of diamine components is 75 mol % or more, 80 mol % or more, 85 mol % or more, 90 mol % or more, or 95 mol % or more. In particular, the total amount of the fluoroalkyl-substituted benzidine and the 3,3′-DDS based on 100 mol % of the total amount of diamine components may be in the above-described range.

(Specific example of composition of polyimide 2) In one embodiment, the polyimide resin contains an acid dianhydride (bis-trimellitic anhydride ester) of the above general formula (1) as the acid anhydride and a fluorine-containing aromatic acid dianhydride, and a fluorine-containing diamine as the diamine. The polyimide exhibits high solubility in a low-melting-point halogenated alkyl such as methylene chloride, and the polyimide film tends to exhibit high transparency and mechanical strength.

From the viewpoint of the transparency and the solubility of the polyimide resin, the amount of the acid dianhydrides of the general formula (1) may be 10 to 65 mol %, 15 to 60 mol %, or 20 to 50 mol %, based on 100 mol % of the total amount of acid dianhydride components. Among the acid dianhydrides of the general formula (1), TAHMBP and TMHQ are preferable, and the total amount of TAHMBP and TMHQ may be in the above-described range.

When the content of the acid dianhydride of general formula (1) is 10 mol % or more, the polyimide film tends to have a high pencil hardness and elastic modulus. When the content of the acid dianhydride of general formula (1) is 65 mol % or less, the polyimide film tends to have high transparency.

The content of the fluorine-containing aromatic acid dianhydride may be 30 to 80 mol %, 35 to 75 mol %, or 45 to 75 mol %, based on 100 mol % of the total amount of acid dianhydride components. When the content of fluorine-containing aromatic acid dianhydride is 30 mol % or more, the polyimide film tends to have high transparency. When the content of fluorine-containing aromatic acid dianhydride is 80 mol % or less, the polyimide film tends to have a high pencil hardness and elastic modulus.

The content of the fluorine-containing aromatic acid dianhydride may be 40 to 100 mol %, or 60 to 80 mol %, based on 100 mol % of the total amount of acid dianhydride components. The content of the fluoroalkyl-substituted benzidine may be in the above-described range, and in particular, the content of 2,2′-bis(trifluoromethyl)benzidine may be in the above-described range, because a polyimide resin excellent in transparency can be obtained.

As the diamine component, 60 mol % or less of a sulfonyl group-containing diamine may be contained in addition to the fluorine-containing diamine. The sulfonyl group-containing diamine may be 3,3′-DDS, and the content of 3,3′-DDS may be 20 to 40 mol %.

When a combination of the acid dianhydrides and the diamines is used, and the acid dianhydride components and the diamine components are set within the above-described ranges, respectively, a polyimide can be obtained which has high solubility in a low-boiling-point solvent such as methylene chloride, allows the remaining solvent content to be reduced, and is excellent in transparency and mechanical strength.

(Synthesis of Polyamic Acid)

Polyamic acid can be obtained by, for example, reacting acid dianhydride and diamine in an organic solvent. It is preferable to use equimolar amounts (95:100 to 105:100) of the acid dianhydride and the diamine. It is preferable to dissolve diamine first in a solution, followed by addition of acid dianhydride for suppressing ring-opening of acid dianhydride. When a plurality kinds of diamines and a plurality kinds of acid dianhydrides are added, these may be added at one time, or may be added in a plurality of times. The polyamic acid solution may be obtained generally with a concentration of 5 to 35 wt %, or with a concentration of 10 to 30 wt %.

For polymerization of the polyamic acid, a diamine and an acid dianhydride as raw materials, and an organic solvent capable of dissolving the polyamic acid as a polymerization product can be used without particular limitation. Specific examples of the organic solvent include urea-based solvents such as methylurea and N,N-dimethylethylurea; sulfone-based solvents such as dimethyl sulfoxide, diphenylsulfone and tetramethylsulfone; amide-based solvents such as N,N-dimethyacetamide, N,N-dimethylformamide, N,N′-diethylacetamide, N-methyl-2-pyrrolidone and hexamethylphosphoric triamide; alkyl halide-based solvents such as chloroform and methylene chloride; aromatic hydrocarbon-based solvents such as benzene and toluene; ether-based solvents such as tetrahydrofuran, 1,3-dioxolane, 1,4-dioxane, dimethyl ether, diethyl ether and p-cresol methyl ether; and eater-based solvents such as y-butyrolactone. Among them, dimethylacetamide, dimethylformamide, or N-methylpyrrolidone is preferable used because it is excellent in polymerization reactivity and polyamic acid solubilizing property.

<Preparation of Polyimide Film>

Polyimide can be obtained by dehydration and cyclization of the polyamic acid. Examples of the method for preparing a polyimide film include a method in which a polyamic acid solution is applied in a film form onto a support, the solvent is removed by drying, and the polyamic acid is imidized; and a method in which a polyimide acid solution is imidized, the resulting polyimide resin is dissolved in a solvent to obtain a solution, the solution is applied in a film form onto a support, and the solvent is removed by drying. When the solubility of the polyimide resin in a solvent is low, the former method is used. For a soluble polyimide, either of the methods can be used for forming a film. The latter method is preferable from the viewpoint of obtaining a polyimide fin having a small amount of residual impurities and having high transparency.

For imidization in solution, a chemical imidization method is suitable in which a dehydration agent, an imidization catalyst, etc. are added to the polyamic acid solution. The polyamic acid solution may be heated to accelerate the progress of imidization. A tertiary amine is used as the imidization catalyst. Among tertiary amines, heterocyclic tertiary amines such as pyridine, picoline, quinoline and isoquinoline are preferable. As the dehydrating agent, acid anhydrides such as acetic anhydride, propionic anhydride, butyric anhydride, benzoic anhydride and trifluoroacetic anhydride are used.

Although the polyimide solution obtained by imidization of the polyamic acid may be used as it is as a solution for film formation, it is preferable that a polyimide resin is once precipitated as a solid substance. When the polyimide resin is precipitated as a solid substance, impurities and residual monomer components generated during polymerization of the polyamic acid, and dehydration agent, imidization catalyst, etc. can be washed and removed. Thus, a polyimide fin excellent in transparency and mechanical properties can be obtained.

By mixing the polyimide solution and the poor solvent, the polyimide resin is precipitated. The poor solvent is a poor solvent of the polyimide resin, one miscible with a solvent in which the polyimide resin is dissolved, and examples thereof include water and alcohols. The poor solvent may be an alcohol such as isopropyl alcohol, 2-butyl alcohol, 2-pentyl alcohol, phenol, cyclopentyl alcohol, cyclohexyl alcohol or t-butyl alcohol, or isopropyl alcohol, because side reactions such as ring-opening of the polyimide hardly occur. Since a small amount of imidization catalyst, dehydration agent, etc. may remain in the precipitated polyimide resin, it is preferable to wash the polyimide resin with a poor solvent. It is preferable to remove the poor solvent from the precipitated and washed polyimide resin by vacuum drying, hot air drying, etc.

A polyimide resin solution is prepared by dissolving the polyimide resin and additives in a suitable solvent. The solvent is not particularly limited as long as the polyimide resin is soluble in the solvent. Examples thereof include urea-based solvents, sulfone-based solvents, amide-based solvents, alkyl halide-based solvents, aromatic hydrocarbon-based solvents and ether-based solvents shown above as organic solvents to be used for polymerization of the polyamic acid. In addition to the above-mentioned solvents, ketone-based solvents such as acetone, methyl ethyl ketone, methyl propyl ketone, methyl isopropyl ketone, methyl isobutyl ketone, diethyl ketone, cyclopentanone, cyclohexanone and methyl cyclohexanone may be used as the solvent.

The polyimide resin solution may contain resin components other than the polyimide, and additives. Examples of the additives include crosslinkers, dyes, surfactants, leveling agents, plasticizers, and fine particles. The content of the polyimide resin based on 100 parts by weight of the solid content of the polyimide solution may be 60 parts by weight or more, 70 parts by weight or more, or 80 parts by weight or more. In other words, the content of the polyimide resin in the polyimide film may be 60 wt % or more, 70 wt % or more, or 80 wt % or more.

A polyimide fil can be obtained by applying a polyimide resin solution onto a support, and removing the solvent by drying. It is preferable to perform heating the solvent during drying. The heating temperature is not particularly limited, and is appropriately set at room temperature to about 250° C. The heating temperature may be elevated stepwise. As the support to which the polyimide solution is applied, a glass substrate, a metal substrate, a metal drum or a metal belt made of SUS or the like, a plastic film, or the like can be used. From the viewpoint of improving productivity, it is preferable to produce a film by a roll-to-roll process using an endless support such as a metal drum or a metal belt, a long plastic film or the like as a support. When a plastic film is used as the support, a material that is not soluble in a deposition dope solvent may be appropriately selected, and as the plastic material, polyethylene terephthalate, polycarbonate, polyacrylate, polyethylene naphthalate or the like is used.

The thickness of the polyimide film is not particularly limited, and may be appropriately set according to a use purpose. The thickness of the polyimide film is, for example, 5 μm or more. From the viewpoint of imparting a self-supporting property to the polyimide film peeled from the support, the thickness of the polyimide film may be 20 μm or more, 25 μm or more, or 30 μm or more. When the polyimide film is used for cover window materials for displays, which are required to have strength, the thickness of the polyimide film may be 40 μm or more, or 50 μm or more. The upper limit of the thickness of the polyimide film is not particularly limited, and may be 200 μm or less, or 150 μm or less, from the viewpoint of flexibility and transparency.

Although a method using a solution of a soluble polyimide resin has been mainly described as a method for preparing a polyimide film, as described above, imidization may be performed by applying a polyamic acid solution in a film form onto a support and heating the polyamic acid on the support. In addition, the gel film freed of the solvent may be peeled from the support, and then heated to be imidized.

[Hard Coat Composition]

The hard coat composition for forming a hard coat layer on the polyimide film is a photocurable resin composition containing a siloxane compound.

<Siloxane Compound>

The siloxane compound contained in the resin composition for forming a hard coat layer has an alicyclic epoxy group as a photocationically polymerizable functional group. The alicyclic epoxy group may be a 3,4-epoxycyclohexyl group. As the siloxane compound, for example, the photocurable siloxane compound described in WO2014/204010 can be used.

The siloxane compound having an alicyclic epoxy group can be obtained by, for example, (1) condensation of a silane compound having an alicyclic epoxy group; or (2) hydrosilylation reaction of a compound having a carbon-carbon double bond reactive with an SiH group and an alicyclic epoxy group in one molecule (e.g., vinylcyclohexene oxide) and a polysiloxane compound having at least two SiH groups in one molecule. A siloxane compound obtained by the above-described method (1) is preferable because a siloxane compound having a siloxane bond network and having a large number of alicyclic epoxy groups in one molecule can be obtained.

Examples of the silane compound having an alicyclic epoxy group include compounds of the following general formula (I).

Y—R¹—(Si(OR²)ₓR³₃₋ₓ) (I)

In the general formula (I), Y is an alicyclic epoxy group, and R¹ is an alkylene group having 1 to 10 carbon atoms. R² is a monovalent hydrocarbon group selected from a hydrogen atom, an alkyl group having 1 to 10 carbon atoms, an aryl group having 6 to 25 carbon atoms and an aralkyl group having 7 to 12 carbon atoms. R³ is a hydrogen atom or an alkyl group having 1 to 10 carbon atoms. x is an integer of 1 to 3. When x is 2 or more, two or more R²s may be the same or different. When (3-x) is 2 or more, two or more R³s may be the same or different.

Examples of the alicyclic epoxy group Y include a 3,4-epoxycyclohexyl group. The alkylene group R¹ may be linear or branched, and may be a linear alkylene group, a linear alkylene having 1 to 5 carbon atoms, or ethylene. In other words, the substituent Y—R¹— bonded to Si may be β-(3,4-epoxycyclohexyl)ethyl.

Specific examples of R² include a hydrogen atom, a methyl group, an ethyl group, a propyl group, a butyl group, a pentyl group, a hexyl group, an octyl group, a nonyl group, a decyl group, a phenyl group, a tolyl group, a xylyl group, a naphthyl group, a benzyl group and a phenethyl group. From the viewpoint of enhancing the reactivity of the alicyclic epoxy group in photocationic polymerization of the siloxane compound, R² may be an alkyl group having 1 to 4 carbon atoms, or an ethyl group or a propyl group.

Specific examples of R³ include a hydrogen atom, a methyl group, an ethyl group, a propyl group, a butyl group, a pentyl group, a hexyl group, an octyl group, a nonyl group and a decyl group. From the viewpoint of promoting condensation of the silane compound, R³ may be an alkyl group having 1 to 3 carbon atoms, or a methyl group.

From the viewpoint of forming a net-shaped siloxane compound, and increasing the number of alicyclic epoxy groups in the siloxane compound to increase the hardness of the cured film, x in the general formula (I) may be 2 or 3. A silane compound with x being 2 or 3 and a silane compound with x being 1 may be used in combination for the purpose of, for example, adjusting the molecular weight of the siloxane compound obtained by condensation.

Specific examples of the silane compound of the general formula (I) include B-(3,4-epoxycyclohexyl)ethyltrimethoxysilane, β-(3,4-epoxycyclohexyl)ethylmethyldimethoxysilane, β-(3,4-epoxycyclohexyl)ethyldimethylmethoxysilane, γ-(3,4-epoxycyclohexyl)propyltrimethoxysilane, γ-(3,4-epoxycyclohexyl)propylmethyldimethoxysilane, and γ-(3,4-epoxycyclohexyl)propyldimethylmethoxysilane.

Reaction of the Si—OR² moiety of the silane compound forms an Si—O—Si bond to produce a siloxane compound. An alicyclic epoxide such as an epoxycyclohexyl group has high electrophilic reactivity and low nucleophilic reactivity. Thus, from the viewpoint of suppressing ring opening of the epoxy group, it is preferable to carry out the reaction under neutral or basic conditions.

Examples of the basic compound to be used for making the reaction system basic include hydroxides of alkali metals and alkali earth metals such as sodium hydroxide, lithium hydroxide and magnesium hydroxide, and amines. If a basic compound is present during formation of the hard coat layer (photocuring reaction), an acid generated from a photocationic initiator (photoacid generator) is quenched by a basic compound, resulting in hindrance to photocationic polymerization reaction of the alicyclic epoxy group. Thus, the basic compound used for forming the siloxane compound may be one that can be removed by volatilization. From the viewpoint of suppressing ring-opening of the epoxy group of the siloxane compound, it is preferable that the basic compound has low nucleophilicity. Thus, the basic compound may be a tertiary amine, or a tertiary amine having a boiling point of to 160° C., such as triethylamine, diethylmethylamine, tripropylamine, methyldiisopropylamine or diisopropylethylamine. The reaction may be carried out with a neutral salt as described in WO 2016/052413.

From the viewpoint of enhancing the hardness of a cured film, the weight average molecular weight of the siloxane compound obtained by condensation of the silane compound may be 500 or more. From the viewpoint of suppressing volatilization of the siloxane compound, the weight average molecular weight of the siloxane compound may be 500 or more. On the other hand, if the molecular weight is excessively large, cloudiness may occur due to, for example, a decrease in compatibility with other compositions. Thus, the weight average molecular weight of the siloxane compound may be 20000 or less. The weight average molecular weight of the siloxane compound may be 1000 to 18000, 1500 to 16000, 2000 to 14000, or 2800 to 12000.

It is preferable that the siloxane compound may have a plurality of alicyclic epoxy groups in one molecule. When the number of alicyclic epoxy groups present in one molecule of the siloxane compound increases, the crosslink density during photocuring tends to increase, leading to enhancement of the mechanical strength of the cured film. The number of alicyclic epoxy groups in one molecule of the siloxane compound may be 3 or more, 4 or more, or 5 or more. On the other hand, if the number of alicyclic epoxy groups present in one molecule is excessively large, the ratio of functional groups that do not contribute to intermolecular cross-linking during curing may increase. Thus, the number of alicyclic epoxy groups in one molecule of the siloxane compound may be 100 or less, 80 or less, 70 or less, or 60 or less.

From the viewpoint of increasing the crosslink point density to improve the hardness and scratch resistance of the cured product, the residual ratio of alicyclic epoxy groups in the siloxane compound obtained by reaction of the silane compound of the general formula (I) may be high. The ratio of the number of moles of the alicyclic epoxy group in the condensate to the number of moles of alicyclic epoxy groups in the silane compound may be 20% or more, 40% or more, or 60% or more. As described above, the residual ratio of alicyclic epoxy groups can be increased by appropriately selecting the pH of the reaction, and the neutral salt or the basic compound.

From the viewpoint of suppressing side reactions during photocuring, and the hardness of the cured product, the number of OR² groups remaining per silane compound unit in the siloxane compound may be small. The number of OR² groups per Si atom in the siloxane compound is 2 or less. The average number of OR² groups per Si atom may be 1.5 or less, or 1.0 or less. From the viewpoint of the flex resistance of the cured product, the average number of OR² groups per Si atom in the siloxane compound may be 0.01 or more, 0.05 or more, or 0.3 or more.

When a siloxane compound is obtained by condensation of a silane compound, a silane compound having no alicyclic epoxy group may be used in addition to a silane compound having an alicyclic epoxy group. A silane compound having no alicyclic epoxy group is represented by, for example, the following general formula (II).

R⁴—(Si(OR²)₃ (I)

R⁴ in the general formula (II) is a monovalent group having no alicyclic epoxy group, and is selected from the group consisting of a substituted or unsubstituted alkyl group having 1 to 10 carbon atoms, an alkenyl group, and a substituted aryl group. When R⁴ is a substituted alkyl group, examples of the substituent include a glycidyl group, a thiol group, an amino group, a (meth)acryloyl group, a phenyl group, a cyclohexyl group and a halogen. R² in general formula (II) is identical to R² in general formula (I).

As described above, from the viewpoint of enhancing the mechanical strength of the cured film, it is preferable that the number of alicyclic epoxy groups present in one molecule of the siloxane compound is large. Thus, the siloxane compound obtained by reaction of the silane compound may be one obtained by condensation of a silane compound having an alicyclic epoxy group (compound of general formula (I)) and a silane compound having no alicyclic epoxy group (compound of general formula (II)), where the molar ratio of the latter compound to the former compound is 2 or less. The molar ratio of the compound of the general formula (II) to the compound of the general formula (I) may be 1 or less, 0.6 or less, 0.4 or less, or 0.2 or less. The molar ratio of the compound of the general formula (II) to the compound of the general formula (I) may be 0.

From the viewpoint of forming a hard coat layer excellent in mechanical strength, the content of the siloxane compound in the hard coat composition may be 40 parts by weight or more, 50 parts by weight or more, or 60 parts by weight or more, based on 100 parts by weight of the total of solid components.

<Photocationic Polymerization Initiator>

It is preferable that the hard coat composition contains a photocationic polymerization initiator. The photocationic polymerization initiator is a compound (photoacid generator) which generates an acid by irradiation with an active energy ray. The acid generated from the photoacid generator causes the alicyclic epoxy group of the siloxane compound to react, so that an intermolecular crosslinkage is formed to cure the hard coat material.

Photoacid generators include strong acids such as toluenesulfonic acid and boron tetrafluoride; onium salts such as sulfonium salts, ammonium salts, phosphonium salts, iodonium salts and selenium salt; iron-allene complexes; silanol-metal chelate complexes; sulfonic acid derivatives such as disulfones, disulfonyldiazomethanes, disulfonylmethanes, sulfonylbenzoylmethanes, imidesulfonates and benzoinsulfonates; and organic halogen compounds.

Among the above photoacid generators, aromatic sulfonium salts or aromatic iodonium salts are preferable because the hard coat composition containing a siloxane compound having an alicyclic epoxy group has high stability. In particular, the aromatic sulfonium salt or the aromatic iodonium salt may be one in which the counter anion is a fluorophosphate-based anion, a fluoroantimonate-based anion or a fluoroborate-based anion because it is easy to obtain a hard coat layer which is quickly photocured, and has excellent adhesion with the polyimide film. In particular, the counter anion may be a fluorophosphate-based anion or a fluoroantimonate-based anion. Specific examples of the photoacid generator include diphenyl(4-phenylthiophenyl)sulfonium hexafluorophosphate; hexafluorophosphate derivatives in which some or all of fluorine atoms of hexafluorophosphate are substituted with perfluoroalkyl groups; and diphenyl(4-phenylthiophenyl)sulfonium hexafluoroantimonate.

The content of the photocationic polymerization initiator in the hard coat composition may be 0.05 to 10 parts by weight, 0.1 to 5 parts by weight, or 0.2 to 2 parts by weight, based on 100 parts by weight of the siloxane compound.

<Particles>

The hard coat composition may contain particles for the purpose of, for example, adjusting the film characteristics or suppressing curing shrinkage. As the particles, organic particles, inorganic particles, organic-inorganic composite particles and the like may be appropriately used. Examples of the material of the organic particles include poly(meth)acrylic acid alkyl esters, crosslinked poly(meth)acrylic acid alkyl esters, crosslinked styrene, nylon, silicone, crosslinked silicone, crosslinked urethane and crosslinked butadiene. Examples of the material of the inorganic particles include metal oxides such as silica, titania, alumina, tin oxide, zirconia, zinc oxide and antimony oxide; metal nitrides such as silicon nitride and boron nitride; and metal salts such as calcium carbonate, calcium hydrogenphosphate, calcium phosphate and aluminum phosphate. Examples of the organic-inorganic composite filler include those having an inorganic layer formed on the surfaces of organic particles, and those having an organic layer or organic fine particles formed on the surfaces of inorganic particles.

The shape of the particle may be a spherical shape, a powder shape, a fibrous shape, a needle shape, a scale shape, etc. The spherical particles have no anisotropy and hardly cause uneven distribution of stress, so that occurrence of strain is suppressed, which can contribute to suppression of warpage of the film due to curing shrinkage, etc.

The average particle diameter of the particles is, for example, about 5 nm to 10 μm. From the viewpoint of enhancing the transparency of the hard coat layer, the average particle size may be 1000 nm or less, 500 nm or less, 300 nm or less, or 100 nm or less. The particle diameter can be measured by a laser diffraction/scattering type particle diameter distribution measuring apparatus, and the volume-based median diameter is taken as an average particle diameter.

The hard coat composition may contain surface-modified particles. Surface modification of particles tends to improve the dispersibility of the particles in the siloxane compound. When the surfaces of particles are modified with a polymerizable functional group capable of reacting with an alicyclic epoxy group, improvement of film strength and flex resistance can be expected because functional groups on the surfaces of the particles react with alicyclic epoxy groups of the siloxane compound to form a chemical crosslinkage.

Examples of the polymerizable functional group capable of reacting with the alicyclic epoxy group include a vinyl group, a (meth)acrylic group, a hydroxyl group, a phenolic hydroxyl group, a carboxy group, an acid anhydride group, an amino group, an epoxy group and an oxetane group. Among them, an epoxy group is preferable. In particular, particles surface-modified with an alicyclic epoxy group are preferable because a chemical crosslinkage can be formed between the particle and the siloxane compound in curing of the hard coat composition by photocationic polymerization.

Examples of particles having a reactive functional group on the surfaces thereof include surface-modified inorganic particles and core-shell polymer particles.

(Inorganic Particles)

The surface hardness of the cured film tends to be improved by adding inorganic particles into the hard coat composition. In particular, by using metal oxide particles, the surface hardness tends to be improved while the adhesion, the scratch resistance and the flex resistance, etc. of the cured film can be controlled. Examples of the metal oxide include silica, titania, alumina, tin oxide, zirconia, zinc oxide and antimony oxide. Among them, silica particles are preferable because they are easily surface-modified with an organic substance, and have excellent dispersibility.

The metal oxide particles may be added to the hard coat composition as a colloid (solvent dispersion sol). From the viewpoint of the compatibility of the hard coat composition with other components, and the dispersibility of particles, the colloid dispersion medium may be an organic solvent. Examples of the organic solvent include alcohols such as methanol, ethanol, isopropanol, butanol and octanol; ketones such as acetone, methyl ethyl ketone, methyl isobutyl ketone and cyclohexanone; esters such as ethyl acetate, butyl acetate, ethyl lactate and δ-butyrolactone; ethers such as ethylene glycol monomethyl ether and diethylene glycol monobutyl ether; aromatic hydrocarbons such as benzene, toluene and xylene; and amides such as dimethylformamide, dimethylacetamide and N-methylpyrrolidone.

The content of the inorganic particles in the hard coat composition may be 3 parts by weight or more, 5 parts by weight or more, or 7 parts by weight or more, based on 100 parts by weight of the siloxane resin. In particular, from the viewpoint of improving the surface hardness of the hard coat film, the content of the surface-modified inorganic particles may be in the above-described range. The surface hardness tends to be improved as the addition amount of the surface-modified inorganic particles increases. On the other hand, if the content of the particles is excessively large, flex resistance may decrease. Thus, the addition amount of the inorganic particles may be 150 parts by weight or less, 100 parts by weight or less, or 80 parts by weight or less, based on 100 parts by weight of the siloxane resin.

(Core-Shell Polymer Particles)

By adding the core-shell polymer particles to the hard coat composition, the flex resistance of the cured film tends to be improved, and in particular, cracking and peeling of the hard coat layer can be suppressed in bending of the hard coat film with the hard coat layer on the outer side.

Examples of the core-shell polymer particles include copolymers including a core layer formed of a first polymer and a shell layer formed of a second polymer that is graft-polymerized on the surface of the core layer. The core-shell polymer particles may have a multi-layer structure of three or more layers.

By graft-polymerizing the vinyl monomer in the presence of the core component, a core-shell polymer can be obtained in which the whole or a part of the surface of a core layer is covered with a shell layer. The core-shell polymer can be manufactured by, for example, emulsion polymerization, suspension polymerization, micro-suspension polymerization, etc. From the viewpoint of controlling the particle diameter, it is preferable to manufacture the polymer by emulsion polymerization.

From the viewpoint of improving the flex resistance of the hard coat layer, the core-shell polymer particles may be core-shell-type rubber particles having a core layer containing an elastomer or a rubber-like copolymer as a main component. It is preferable that the rubber-based polymer forming the core layer has rubber properties at room temperature, and the glass transition temperature of the rubber-based polymer may be 0° C. or lower, or −20° C. or lower. Specific examples of the rubber-based polymer forming the core layer include butadiene rubber, butadiene-styrene rubber, butadiene alkyl acrylate rubber, alkyl acrylate rubber and organosiloxane rubber. In order to maintain a core-shell structure, the core layer may be crosslinked rubber which at least partially has a crosslinked structure.

The average particle diameter of the core layer in the core-shell polymer can be 10 nm or more, 20 nm or more, 30 nm or more, 40 nm or more, 50 nm or more, 60 nm or more, 70 nm or more, 80 nm or more, 90 nm or more, or 100 nm or more. The average particle diameter of the core layer in the core-shell polymer can be 500 nm or less, 400 nm or less, 350 nm or less, 300 nm or less, 250 nm or less, 200 nm or less or 150 nm or less.

Examples of the vinyl monomer forming the shell layer include aromatic vinyl monomers such as styrene, a-methylstyrene, p-methylstyrene and divinylbenzene; vinyl cyanide monomers such as acrylonitrile and methacrylonitrile; alkyl (meth) acrylates such as methyl (meth)acrylate, ethyl (meth)acrylate and butyl (meth)acrylate; glycidyl vinyl monomers such as glycidyl (meth)acrylate and glycidyl vinyl ether; hydroxyalkyl (meth)acrylates such as hydroxyethyl (meth)acrylate and hydroxybutyl (meth)acrylate; alicyclic epoxy group-containing vinyl derivatives such as 4-vinylcyclohexene 1,2-epoxide and epoxycyclohexenyl (meth)acrylate; oxetane group-containing vinyl derivatives such as 2-oxetanylpropyl (meth)acrylate; and divinyl monomers such as ethylene glycol di(meth)acrylate and 1,3-butylene glycol di(meth)acrylate.

It is preferable that the core-shell polymer particles have primary particles independently dispersed in a matrix phase containing the siloxane compound as a main component in the hard coat composition. From the viewpoint of dispersibility of the core-shell particles in the siloxane compound, it is preferable that the shell layer contains one or more reactive functional groups selected from the group consisting of an epoxy group, an oxetanyl group, a carboxyl group, a hydroxyl group and an amino group. Among them, an epoxy group and an oxetanyl are preferable, and an epoxy group is particularly preferable, because such groups have high reactivity with an alicyclic epoxy group.

The core-shell polymer particle includes a rubber polymer core layer in an amount of 50 to 97 wt %, or 70 to 90 wt %, and a shell layer of a polymerized product of the vinyl monomer in an amount of preferably 3 to 50 wt %, or 10 to 30 wt %. If the content of the shell layer is less than 3 wt %, aggregation may easily occur during handling of core-shell polymer particles, leading to deterioration of operability. If the content of the shell layer is more than 50 wt %, the content of the core layer in the core-shell polymer may decrease, leading to deterioration of the flexibility of the cured film.

From the viewpoint of improving the flex resistance of the hard coat film, the content of the core-shell polymer particles in the hard coat composition may be 3 parts by weight or more, 5 parts by weight or more, 7 parts by weight or more, or 10 parts by weight or more, based on 100 parts by weight of the siloxane resin. Flex resistance tends to be improved as the addition amount of the core-shell polymers having a reactive functional group on the shell layer increases. The addition amount of the core-shell polymer particles may be 120 parts by weight or less, 100 parts by weight or less, based on 100 parts by weight of the siloxane resin. If the content of the core-shell polymer particles is excessively high, the surface hardness and the scratch resistance of the hard coat film may decrease. From the viewpoint of surface hardness and scratch resistance, the addition amount of the core-shell polymer particles may be 80 parts by weight or less, 60 parts by weight or less, or 40 parts by weight or less, or may be 30 parts by weight or less, or 20 parts by weight or less, based on 100 parts by weight of the siloxane resin.

The hard coat composition may contain both surface-modified inorganic particles and core-shell polymer particles. In this case, it is preferable that the contents of the inorganic particles and the core-shell polymer particles are in the above-described ranges, respectively. The total content of the particles may be 200 parts by weight or less, 150 parts by weight or less, 100 parts by weight or less, or 80 parts by weight or less, based on 100 parts by weight of the siloxane resin.

<Reactive Diluent>

The hard coat composition may include a reactive diluent. By adding a reactive diluent to the composition, the density of reaction points (crosslink points) in photocationic polymerization may be increased to enhance the curing rate.

As the reactive diluent for photocationic polymerization, a compound having a cationically polymerizable functional group is used. Examples of the cationically polymerizable functional group of the reactive diluent include an epoxy group, a vinyl ether group, an oxetane group and an alkoxysilyl group. In particular, the reactive diluent may be one having an alicyclic epoxy group because of high reactivity with the alicyclic epoxy resin of the siloxane compound.

From the viewpoint of reducing curing shrinkage and improving the mechanical strength of the cured film, the reactive diluent may be one having two or more cationically polymerizable functional groups in one molecule, or one having two or more alicyclic epoxy groups in one molecule. Compounds having two or more alicyclic epoxy groups in one molecule include 3,4-epoxycyclohexylmethyl-3′,4′-epoxycyclohexane carboxylate (“CELLOXIDE 2021P” manufactured by DAICEL CORPORATION), e-caprolactone-modified-3′,4′-epoxycyclohexylmethyl-3,4-epoxycyclohexane carboxylate (“CELLOXIDE 2081” manufactured by DAICEL CORPORATION), bis(3,4-epoxycyclohexylmethyl) adipate, an epoxy-modified chain siloxane compound (“X-40-2669” manufactured by Shin-Etsu Chemical Co., Ltd.) and an epoxy-modified cyclic siloxane compound (“KR-470” manufactured by Shin-Etsu Chemical Co., Ltd.).

The content of the reactive diluent in the hard coat composition may be 100 parts by weight or less, or 50 parts by weight or less, based on 100 parts by weight of the siloxane compound.

<Photosensitizer>

The hard coat composition may contain a photosensitizer for the purpose of, for example, improving photosensitivity. Examples of the photosensitizer include anthracene derivatives, benzophenone derivatives, thioxanthone derivatives, anthraquinone derivatives and benzoin derivatives. Among them, anthracene derivatives, thioxanthone derivatives and benzophenone derivatives are preferable from the viewpoint of a photoinduced electron donating property.

The content of the reactive diluent in the hard coat composition may be 50 parts by weight or less, 30 parts by weight or less, or 10 parts by weight or less, based on 100 parts by weight of the photoacid generator.

<Solvent>

The hard coat composition may be solvent-free or may contain a solvent. The solvent may be one in which the polyimide film is not soluble. On the other hand, use of a solvent having solvency allowing the polyimide film to swell may improve adhesion between the polyimide film and the hard coat layer. Examples of the solvent include ketones such as methyl isobutyl ketone and diisobutyl ketone; alcohols such as butanol and isopropyl alcohol; esters such as butyl acetate and isopropyl acetate; ethers such as diethylene glycol methyl ether and propylene glycol methyl ether; amides such as N,N-dimethylacetamide, N,N-dimethylformamide and N-methyl-2-pyrrolidone; and alkyl halides such as chloroform and methylene chloride. The amount of the solvent may be 500 parts by weight or less, or 300 parts by weight or less, based on 100 parts by weight of the siloxane compound.

<Additives>

The hard coat composition may contain additives such as inorganic pigments, organic pigments, plasticizers, dispersants, wetting agents, thickeners and antifoaming agents. The hard coat composition may contain a thermoplastic or thermosetting resin material other than the siloxane compound. When the resin material other than the siloxane compound and/or the siloxane compound has radical polymerizability, the hard coat composition may contain a photoradical polymerization initiator in addition to the photocationic polymerization initiator.

<Preparation of Hard Coat Composition>

The method for preparing the hard coat composition is not particularly limited. For example, each of the above-described components may be blended, and may be mixed using a hand mixer or a static mixer or the like, or kneaded using a planetary mixer, a disperser, a roll, a kneader or the like. These operations may be performed in a shaded state, if necessary.

[Formation of Hard Coat Layer on Polyimide Film]

The hard coat composition is applied onto a transparent polyimide film, a solvent is removed by drying if necessary, and the hard coat composition is cured by irradiation with an active energy ray to obtain a hard coat-equipped polyimide film in which the hard coat layer 2 is disposed on the polyimide film 1.

The principal surface of the polyimide film may be subjected to surface treatment such as corona treatment or plasma treatment before application of the hard coat layer. An adhesion enhancement layer (primer layer) or the like may be provided on a surface of the polyimide film. Since the hard coat layer formed by curing the hard coat composition of one or more embodiments of the present invention exhibits high adhesion to the polyimide film, it is not necessary to provide an adhesion enhancement layer or the like. In other words, the polyimide film 1 and the hard coat layer 2 may be in contact with each other in the hard coat-equipped polyimide film.

By irradiating the hard coat composition with an active energy ray, an acid is generated from the photocationic polymerization initiator, and the alicyclic epoxy group of the siloxane compound is cationically polymerized, so that curing proceeds. When the hard coat composition contains a reactive diluent, polymerization reaction between the alicyclic epoxy group of the siloxane compound and the reactive diluent takes place in addition to polymerization reaction between siloxane compounds. When the hard coat composition contains particles having a reactive functional group on a surface thereof, the functional group on the surfaces of the particles reacts with the alicyclic epoxy group of the siloxane compound to form a chemical crosslinkage.

Examples of the active energy ray applied during photocuring include visible light, ultraviolet rays, infrared rays, X-rays, a-rays, B-rays, y-rays and electron beams. An ultraviolet ray is preferable as the active light ray because the ultraviolet ray has a high curing reaction rate and excellent energy efficiency. The cumulative radiation amount of the active energy rays is, for example, about 50 to 10000 mJ/cm², and may be set according to the type and the amount of the photocationic polymerization initiator, the thickness of the hard coat layer, etc. The curing temperature is not particularly limited, and is typically 100° C. or lower.

The thickness of the hard coat layer may be 1 μm or more, 2 μm or more, 3 μm or more, or 5 μm or more. The thickness of the hard coat layer may be 100 μm or less, 80 μm or less, 50 μm or less, or 40 μm or less. If the thickness of the hard coat layer is excessively small, it may be impossible to sufficiently improve mechanical properties such as surface hardness. On the other hand, if the thickness of the hard coat layer is excessively large, transparency and flex resistance may decrease.

[Characteristics of Hard Coat-Equipped Polyimide Film]

As described above, the hard coat layer formed by curing the hard coat composition of one or more embodiments of the present invention is excellent in adhesion to the polyimide film. Since the hard coat composition has a polymer matrix in which the siloxane compound is crosslinked by polymerization reaction of the alicyclic epoxy group, the surface hardness comparable to that of glass can be achieved. The pencil hardness of a hard coat layer-formed surface of the hard coat-equipped polyimide film may be 3H or higher, or 4H or higher. In addition, the hard coat layer is excellent in scratch resistance.

The hard coat-equipped polyimide film according to one or more embodiments of the present invention has high surface hardness as described above, and is excellent in flex resistance. In the hard coat-equipped polyimide film, the mandrel diameter at which the hard coat layer is cracked in a cylindrical mandrel test conducted with the hard coat layer-formed surface on the inner side may be 10 mm or less, 5 mm or less, or 3 mm or less.

The total light transmittance of the hard coat-equipped polyimide film may be 80% or more, 85% or more, or 88% or more. The haze of the hard coat-equipped polyimide film may be 2% or less, 1.5% or less, 1% or less, or 0.5% or less.

As described above, during photocuring, an acid is generated from the photocationic polymerization initiator (photoacid generator), so that photocuring proceeds. Thus, the counter anion of the photoacid generator remains in the cured hard coat layer. The hard coat layer may contain a fluorophosphate-based anion, a fluoroantimonate-based anion or a salt thereof as the counter anion of the aforementioned photoacid generator.

When the hard coat composition contains fine particles, the photocured hard coat layer contains fine particles. When the hard coat composition contains fine particles having a polymerizable functional group capable of reacting with an alicyclic epoxy group, it is preferable that the photocured hard coat layer has a chemical crosslinkage formed between the siloxane resin and the fine particle.

[Application of Hard Coat-Equipped Polyimide Film]

In the hard coat-equipped polyimide film, various functional layers may be provided on the hard coat layer or on a hard coat layer-non-formed surface of the polyimide film. Examples of the functional layer include an antireflection layer, an antiglare layer, an antistatic layer and a transparent electrode. A transparent pressure sensitive adhesive layer may be disposed on the hard coat film.

The hard coat-equipped polyimide film according to one or more embodiments of the present invention has high transparency and excellent mechanical strength, and can be therefore suitably used for cover windows arranged on surfaces of image display panels, transparent substrates for displays, transparent substrates for touch panels, substrates for solar cells, etc. The hard coat-equipped polyimide film of one or more embodiments of the present invention is excellent in flex resistance in addition to transparency and mechanical strength, and therefore can be particularly suitably used as a cover window or a substrate film for curved displays and flexible displays.

### EXAMPLES

Hereinafter, one or more embodiments of the present invention will be described in detail on the basis of examples and comparative examples. One or more embodiments of the present invention are not limited to the following examples.

[Polyimide Film]

### <Polyimide Film 1>

(Preparation of Polyamic Acid Solution 1)

383 parts by weight of N,N-dimethylformamide (DMF) was added into a reaction vessel, and stirred under a nitrogen atmosphere. Thereto were added 36.3 parts by weight of 2,2′-bis(trifluoromethyl)benzidine, 12.0 parts by weight of 3,3′-diaminodiphenysulfone parts by weight, 15.8 parts by weight of 1,2,3,4-cyclobutanetetracarboxylic dianhydride and 35.9 parts by weight of 2,2-bis(3,4-dicarboxyphenyl)-1,1,1,3,3,3-hexafluoropropane dianhydride in this order, and the mixture was stirred in a nitrogen atmosphere to obtain a polyamic acid solution 1.

(Imidization and Extraction of Polyimide Resin)

38.4 parts by weight of pyridine as an imidization catalyst was added to the polyimide acid solution (100 parts by weight of solid content of polyamic acid). The mixture was stirred, 49.5 parts by weight of acetic anhydride was added, and the mixture was stirred at 120° C. for 2 hours, and then cooled to room temperature to obtain a polyimide solution. A polyimide resin was precipitated by adding dropwise 1 L of isopropyl alcohol while stirring the solution. Thereafter, the filtered polyimide resin was washed with isopropyl alcohol three times, and then dried at 120° C. for 12 hours to obtain white polyimide resin 1 (PI-1) powder.

(Preparation of Polyimide Film 1)

The polyimide resin 1 was dissolved in methyl ethyl ketone to obtain a polyimide solution having a solid content concentration of 17%. The polyimide solution was applied onto an alkali-free glass plate with a comma coater, dried at 40° C. for 10 minutes, at 80° C. for 30 minutes, at 150° C. for 30 minutes and at 170° C. for 1 hour in an air atmosphere, and then peeled from the alkali-free glass plate to obtain a transparent polyimide film 1 having a thickness of 80 μm or 50 μm. The total light transmittance of the polyimide film 1 having a thickness of 80 μm was 89.8%, and the total light transmittance of the polyimide film 1 having a thickness of 50 μm was 90.0%.

<Polyimide Film 2>

### (Preparation of Polyamic Acid Solution 2, Imidization and Precipitation of Polyimide Resin)

383 parts by weight of DMF was added into a reaction vessel, and stirred in a nitrogen atmosphere. 31.8 parts by weight of 2,2′-bis(trifluoromethyl)benzidine and 10.5 parts by weight of 3,3′-diaminodiphenylsulfone were added thereto, and the mixture was stirred in a nitrogen atmosphere to obtain a diamine solution. Thereto were added 15.9 parts by weight of p-phenylenebis(trimellitic anhydride), 37.4 parts by weight of 2,2-bis(3,4-dicarboxyphenyl)-1,1,1,3,3,3-hexafluoropropanoic acid dianhydride and 10.4 parts by weight of 3,3′,4,4′-biphenyltetracarboxylic dianhydride, and the mixture was stirred in a nitrogen atmosphere to obtain a polyamic acid solution 2. White polyimide resin 2 (PI-2) powder was obtained by performing imidization, precipitation of polyimide resin, washing and drying in the same manner as in preparation of the polyimide resin 1 with the use of the obtained polyamic acid solution 2.

(Preparation of Polyimide Film 2)

The polyimide resin 2 was dissolved in methylene chloride to obtain a polyimide solution having a solid content concentration of 10%. The polyimide solution was applied onto an alkali-free glass plate with a comma coater, dried at 40° C. for 10 minutes, at 80° C. for 30 minutes, at 150° C. for 30 minutes and at 170° C. for 30 minutes in an air atmosphere, and then peeled from the alkali-free glass plate to obtain a transparent polyimide film 2 having a thickness 50 μm. The total light transmittance of the polyimide film 2 was 89.0%.

[Preparation of Hard Coat Resin Composition]

100 parts by weight of 8-(3,4-epoxycyclohexyl)ethyltrimethoxysilane (“SILQUEST A-186” manufactured by Momentive Performance Materials Inc.), 0.12 parts by weight of magnesium chloride, 11 parts by weight of water and 11 parts by weight of propylene glycol monomethyl ether were added into a reaction vessel, the mixture was stirred at 130° C. for 3 hours, and then devolatilized under reduced pressure at 60° C. to obtain a condensate (siloxane resin).

100 parts by weight of the siloxane resin, 161.6 parts by weight of propylene glycol monomethyl ether, 2 parts by weight of a propylene carbonate solution of triaryl sulfonium/SbF₆ salt (“CPI-101A” manufactured by San-Apro Ltd.) as a photoacid generator and 0.2 parts by weight, in terms of a solid content, of a xylene/isobutanol solution of polyether-modified polydimethylsiloxane (“BYK-300” manufactured by BYK) as a leveling agent were added to obtain a hard coat composition.

### Example 1: Preparation of Hard Coat Film 1

The hard coat composition was applied to a surface of an 80 μm-thick transparent polyimide film 1 with a bar coater to a dry thickness of 10 μm, and heated at 120° C. for 2 minutes. Thereafter, using a high-pressure mercury lamp, an ultraviolet ray was applied to a cumulative light amount of 1000 mJ/cm² at a wavelength of 250 to 390 nm to cure the hard coat composition. In this way, a hard coat-equipped polyimide film (hard coat film 1) was obtained.

### Example 2: Preparation of Hard Coat Film 2

Except that the coating thickness was changed so that the thickness of the hard coat layer was 40 μm, the same procedure as in Example 1 was carried out to obtain a hard coat-equipped polyimide film (hard coat film 2).

### Example 3: Preparation of Hard Coat Film 3

Except that the 50 μm-thick transparent polyimide film 1 was used, the same procedure as in Example 2 was carried out to obtain a hard coat-equipped polyimide film (hard coat film 3).

### Example 4: Preparation of Hard Coat Film 4

Except that the 50 μm-thick transparent polyimide film 2 was used, and the addition amount of the photoacid generator in the hard coat resin composition was changed to 0.2 parts by weight based on 100 parts by weight of the siloxane resin, the same procedure as in Example 1 was carried out to obtain a hard coat-equipped polyimide film (hard coat film 4).

### Example 5: Preparation of Hard Coat Film 5

Except that the coating thickness was changed so that the thickness of the hard coat layer was 40 μm, the same procedure as in Example 4 was carried out to obtain a hard coat-equipped polyimide film (hard coat film 5).

### Comparative Examples 1 to 4

10 μm-thick hard coat layers were formed on film surfaces in the same manner as in Example 1 except that as base films, a 50 μm-thick polyethylene terephthalate (PET) film (L-50T60 manufactured by Toray Industries, Inc.), a 40 μm-thick acryl-based film, a 50 μm-thick polyethylene naphthalate (PEN) film (Teonex Q51 manufactured by Teijin Limited) and an 80 μm-thick triacetylcellulose (TAC) film were used instead of the polyimide film. The acrylic film and the TAC film were prepared by solution deposition using a methylene chloride solution of an acrylic resin (PARAPET HR-G manufactured by KURARAY CO., LTD) and a triacetyl cellulose resin (manufactured by Wako Pure Chemical Industries, Ltd.), respectively.

[Evaluation]

The hard coat films obtained in Examples and Comparative Examples were evaluated in accordance with the following procedures.

<Adhesion of Hard Coat Layer>

A cross-cut having 100 squares at intervals of 1 mm was made in the hard coat layer, a cross-cut test was conducted in accordance with JIS K5600-5-6: 1999, and the ratio of cells with the hard coat layer peeled from the surface of the film (%) was recorded. The smaller the number, the better the adhesion of the hard coat layer.

<Flex Resistance>

In accordance with JIS K5600-5-1: 1999, a cylindrical mandrel test was performed using a type 1 testing machine with the hard coat layer-formed surface on the inner side. The smaller the diameter of the mandrel, the better the flex resistance.

<Surface Hardness>

The pencil hardness of the hard coat layer-formed surface was measured according to JIS K5600-5-4: 1999.

<Scratch Resistance>

Using a reciprocating wear testing machine (manufactured by Shinto Scientific Co., Ltd.), steel wool #0000 was reciprocated 10 or 100 times on the surface of the hard coat layer while a load of 162 g/cm² was applied to the surface, followed by visually checking whether scratches were present or not. Samples having no scratches were rated “OK”, and samples having scratches were rated “NG”.

<Total Light Transmittance and Haze>

Measurement was performed by the methods described in JIS K7361-1: 1999 and JIS K7136: 2000 using a haze meter “HZ-V3” manufactured by Suga Test Instruments Co., Ltd.

Table 1 shows the configurations of the hard coat films 1 to 5 prepared in Examples 1 to 5 and the hard coat films of Comparative Examples 1 to 4, and the evaluation results.

TABLE 1

| | | | | | | | | Comparative | Comparative | Comparative | Comparative |
|---|---|---|---|---|---|---|---|---|---|---|---|
| hard coat film | | | 1 | 2 | 3 | 4 | 5 | Example 1 | Example 2 | Example 3 | Example 4 |
| base film | resin | | PI-1 | PI-1 | PI-1 | PI-2 | PI-2 | PET | Acryl | PEN | TAC |
| | thickness (μm) | | 80 | 80 | 50 | 50 | 50 | 50 | 40 | 50 | 80 |
| HC | thickness (μm) | | 10 | 40 | 40 | 10 | 40 | 10 | 10 | 10 | 10 |
| evaluation | cross-cut (%) | | 0 | 0 | 0 | 0 | 0 | 34 | 69 | 96 | 100 |
| result | mandrel (mm) | | 2 | 2 | 2 | 2 | 2 | 2 | 2 | 2 | 3 |
| | pencil hardness | | 4H | 9H | 8H | 4H | 6H | 2H | 3H | 3H | 3H |
| | scratch | 10 | OK | OK | OK | OK | OK | OK | OK | OK | OK |
| | resistance | times | | | | | | | | | |
| | test | 100 | OK | OK | OK | OK | OK | OK | OK | OK | NG |
| | | times | | | | | | | | | |

| | | | | | | | | | |
|---|---|---|---|---|---|---|---|---|---|
| haze (%) | 0.2 | 1.6 | 0.3 | 0.3 | 0.6 | 1.4 | 0.5 | 12.3 | 0.1 |
| total light | 90.6 | 89.6 | 90.7 | 90.1 | 89.9 | 89.3 | 91.9 | 88.0 | 91.9 |
| transmittance (%) | | | | | | | | | |

The hard coat film 1 with a 10 μm hard coat layer formed on a 80 μm-thick transparent polyimide film 1 had a high pencil hardness of 4H, and good flex resistance and scratch resistance, did not undergo peeling of the hard coat layer in the cross-cut test, and thus exhibited good characteristics. The hard coat film 2 in which the thickness of the hard coat layer was increased to 40 μm had a high pencil hardness of 9H. The hard coat film 3 with a 40 μm hard coat layer formed on the 50 μm-thick transparent polyimide film 1 did not undergo peeling of the hard coat layer in the cross-cut test, and had a high hardness. Similar to the hard coat films 1 to 3, the hard coat films 4 and 5 with a hard coat layer formed on the 50 μm-thick polyimide film 2 did not undergo peeling of the hard coat layer in the cross-cut test, and exhibited a high hardness.

Comparative Examples 1 to 4 using a base film other than the polyimide film had a lower pencil hardness as compared to the hard coat film 1, underwent peeling of the hard coat layer in the cross-cut test, and was thus poor in adhesion. Comparative Example 4 had low scratch resistance.

The above results show that a hard coat composition containing a siloxane compound having an alicyclic epoxy group is capable of forming a hard coat film which exhibits specifically high adhesion to a polyimide film and is excellent in mechanical strength.

[Preparation of Hard Coat Films 6-9]

In preparation of a hard coat resin composition, a dispersion liquid of a siloxane resin and core-shell polymer (core-shell rubber) particles prepared in the following procedure was added instead of 100 parts by weight of the siloxane resin. The composition ratio was as shown in Table 2 (the amount of core-shell rubber particles in Table 2 is a solid content). Except for the above, the same procedure as in preparation of the hard coat film 1 was carried out. That is, the hard coat composition was applied to a surface of the transparent polyimide film, dried by heating, and then photocured by irradiation with an ultraviolet ray to obtain hard coat-equipped polyimide films (hard coat films 6 to 9) in which a 10 μm-thick hard coat layer is provided on a polyimide film.

(Preparation of Core-Shell Rubber Particles)

200 parts by weight of water, 0.03 parts by weight of tripotassium phosphate, 0.25 parts by weight of potassium dihydrogen phosphate, 0.002 parts by weight of ethylenediamine tetraacetic acid, 0.001 parts by weight of ferrous sulfate and 1.5 parts by weight of sodium dodecylbenzenesulfonate were added into a pressure-resistant polymerization vessel. Washing with nitrogen was sufficiently performed with stirring to remove oxygen, 75 parts by weight of butadiene and 25 parts by weight of styrene were then added into the system, and the mixture was heated to 45° C. 0.015 parts by weight of para-menthane hydroperoxide and 0.04 parts by weight of sodium formaldehyde sulfoxylate (SFS) were added in this order to start polymerization. 4 hours after the start of the polymerization, 0.01 parts by weight of para-menthane hydroperoxide, 0.0015 part by weight of ethylenediaminetetraacetic acid (EDTA) and 0.001 part by weight of ferrous sulfate were added. 10 hours after the start of the polymerization, the residual monomer was devolatilized and removed under reduced pressure to complete the polymerization. The volume average particle diameter of the obtained styrene-butadiene rubber latex was 100 nm.

241 parts by weight of the styrene-butadiene rubber latex (including 80 parts by weight of styrene-butadiene rubber particles) and 65 parts by weight of water were added into a glass reactor, and the mixture was stirred at 60° C. while washing with nitrogen was performed. 0.004 parts by weight of EDTA, 0.001 parts by weight of ferrous sulfate heptahydrate and 0.2 parts by weight of SFS were added, 2 parts by weight of triaryl isocyanurate (TAIC) and 0.07 parts by weight of cumene hydroperoxide (CHP) were then added, and the mixture was stirred for 60 minutes. A mixture of 11.7 parts by weight of styrene, 4.3 parts by weight of acrylonitrile, 4 parts by weight of glycidyl methacrylate and 0.08 parts by weight of t-butyl hydroperoxide (TBP) was continuously added over 110 minutes. Thereafter, 0.04 parts by weight of TBP was added, and the mixture was continuously stirred for 1 hour to complete the polymerization. In this way, an aqueous latex containing a core-shell polymer was obtained. The volume average particle diameter of the core-shell polymer contained in the obtained aqueous latex was 110 nm.

126 parts by weight of methyl ethyl ketone (MEK) was added into a mixing tank at 30° C., and 126 parts by weight of the aqueous latex was added with stirring. The mixture was homogeneously mixed, and 200 parts by weight of water was added at a supply rate of 80 parts by weight/min. After completion of the supply of the mixture, stirring was immediately stopped to obtain a slurry liquid containing floating aggregates. Next, 350 parts by weight of the liquid phase was discharged from a discharge port at the lower part of the tank while the aggregates were allowed to remain. 150 parts by weight of MEK was added to the obtained aggregates, and mixed to obtain a MEK dispersion liquid of core-shell polymer particles.

This dispersion liquid was transferred into a stirring tank equipped with anchor blades, propylene glycol monomethyl ether (PM) was added to a weight ratio of core-shell polymer particles/PM of 30/70, the mixture was homogeneously mixed, the jacket temperature was set to 70° C., MEK and water were distilled off under reduced pressure until the core-shell polymer particle concentration reached 28 wt %. At this time, a small amount of PM was also distilled off by azeotrope. MEK was added to bring the core-shell polymer particle concentration to 11 wt %, MEK, water and a small amount of PM were distilled off under reduced pressure at 70° C. until the core-shell polymer particle concentration reached 38 wt %. Nitrogen gas was introduced into the tank, so that the internal pressure was turned back to atmospheric pressure to obtain a dispersion liquid of core-shell polymer particles. The solvent composition of the dispersion was MEK/PM=30/70, the viscosity of the dispersion liquid at room temperature was 3700 mPa s, and the volume average particle diameter of the core-shell polymer particles was 110 nm.

[Preparation of Hard Coat Films 10 to 12]

In preparation of the hard coat resin composition, 90 parts by weight of a siloxane resin and 10 parts by weight of a liquid acrylic resin shown below were added instead of 100 parts by weight of the siloxane resin. Except for the above, the same procedure as in preparation of the hard coat film 1 was carried out to obtain hard coat-equipped polyimide films (hard coat films 10 to 12) in which a 10 μm-thick hard coat layer is provided on a transparent polyimide film.

UP-1010: “ARUFON UP-1010” manufactured by Toagosei Company, Limited; liquid acrylic resin (weight average molecular weight: 1700)

UG-4010: “ARUFON UG-4010” manufactured by Toagosei Company, Limited; a liquid acrylic resin with an epoxy group in the side chain (weight average molecular weight: 2900) UH-2041: “ARUFON UH-2041” manufactured by Toagosei Company, Limited; a liquid acrylic resin with an OH group in the side chain (weight average molecular weight: 2500)

[Evaluation]

The same evaluations as described above were performed for the hard coat films 6 to 12. In evaluation of flex resistance in the cylindrical mandrel test, evaluation was performed through a test in which the film is bent with the hard coat layer-formed surface on the outer side (outer bending) in addition to a test in which the film is bent with the hard coat layer-formed surface on the inner side (inner bending). Table 2 shows the compositions of the resin components of the hard coat compositions used for preparation of the hard coat films 6 to 12, the evaluation results thereof, and the evaluation results of the hard coat film 1.

TABLE 2

| hard coat film | | | 1 | 6 | 7 | 8 | 9 | 10 | 11 | 12 |
|---|---|---|---|---|---|---|---|---|---|---|
| Base film | resin | | PI-1 | PI-1 | PI-1 | PI-1 | PI-1 | PI-1 | PI-1 | PI-1 |
| | thickness (μm) | | 80 | 80 | 80 | 80 | 80 | 80 | 80 | 80 |
| HC | siloxane resin | | 100 | 90 | 80 | 70 | 60 | 90 | 90 | 90 |
| composition | core-shell rubber particles | | — | 10 | 20 | 30 | 40 | — | — | — |
| | UP-1010 | | — | — | — | — | — | 10 | — | — |
| | UG-4010 | | — | — | — | — | — | — | 10 | — |
| | UH-2041 | | — | — | — | — | — | — | — | 10 |
| evaluation | cross-cut (%) | | 0 | 0 | 0 | 0 | 0 | 100 | 0 | 0 |
| result | mandrel | inner | 2 | 2 | 2 | 2 | 2 | 3 | 2 | 2 |
| | (mm) | bending | | | | | | | | |
| | | outer | | | | | | | | |
| | | bending | 8 | 5 | 5 | 3 | 2 | 13 | 8 | 8 |
| | pencil hardness | | 4H | 4H | 4H | 4H | 3H | 3H | 4H | 4H |
| | scratch | 10 | OK | OK | OK | NG | NG | OK | NG | OK |
| | resistance | times | | | | | | | | |
| | test | | | | | | | | | |

| | | | | | | | | |
|---|---|---|---|---|---|---|---|---|
| haze (%) | 0.2 | 1.4 | 1.4 | 0.9 | 1.1 | 0.4 | 3.2 | 0.9 |
| total light | 90.6 | 90.4 | 90.3 | 90.1 | 90.4 | 90.6 | 90.6 | 90.6 |
| transmittance (%) | | | | | | | | |

The hard coat film 10 with a liquid acrylic resin added to the hard coat composition had considerably low adhesion of the hard coat layer. It is considered that the hard coat film 10 had low adhesion of the hard coat layer because the acrylic resin had no reactive functional group, and the alicyclic epoxy group of the siloxane resin was prevented from reacting with the acrylic resin by photocuring. Although the hard coat films 11 and 12 with the hard coat composition containing a liquid acrylic resin having a reactive functional group was comparable in adhesion, flex resistance and pencil hardness to the hard coat film 1, the hard coat film 11 had low scratch resistance.

The hard coat films 6 and 7 with the hard coat composition containing core-shell rubber particles having a shell layer having an epoxy group were comparable in adhesion, hardness and scratch resistance to the hard coat film 1, and had improved flex resistance in the outer bending mandrel test. In the hard coat film 9 with an increased addition amount of the core-shell rubber particles, the flex resistance in the outer bending mandrel test was further improved, but the mechanical strength was lower as compared to the hard coat film 1.

The above results show that the flex resistance of the hard coat film can be improved by using a composition with a siloxane resin containing core-shell polymer particles. It is shown that by adjusting the amount of core-shell polymer particles, flex resistance can be improved without deteriorating the hardness of the hard coat layer.

[Preparation of Hard Coat Films 13 to 18]

In preparation of the hard coat resin composition, the siloxane resin and a dispersion liquid of silica fine particles shown below were added instead of 100 parts by weight of the siloxane resin. The composition ratio was as shown in Table 3 (the amount of silica particles in Table 3 is a solid content). Except for the above, the same procedure as in preparation of the hard coat film 1 was carried out to obtain hard coat-equipped polyimide films (hard coat films 13 to 18) in which a 10 μm-thick hard coat layer is provided on a transparent polyimide film.

MEK-EC-2430Z: colloid solution of colloidal silica treated at a surface with alicyclic epoxy; manufactured by Nissan Chemical Corporation; particle diameter: 10 to 15 nm; dispersion medium: methyl ethyl ketone; solid content: 30%

MEK-EC-2130Y: colloid solution of colloidal silica hydrophobically treated at a surface; manufactured by Nissan Chemical Corporation; particle diameter: 10 to 15 nm; dispersion medium: methyl ethyl ketone; solid content: 30%

MEK-AC-2140Z: colloid solution of colloidal silica treated at a surface with methacryloyl; manufactured by Nissan Chemical Corporation; particle diameter: 10 to 15 nm; dispersion medium: methyl ethyl ketone; solid content: 40%

PGM-AC-4130Y colloid solution of colloidal silica treated at a surface with methacryloyl; manufactured by Nissan Chemical Corporation; particle diameter: 40 to 50 nm; dispersion medium: propylene glycol monomethyl ether; solid content: 30%

[Evaluation]

The same evaluations as described above were performed for the hard coat films 13 to 18. Table 3 shows the compositions of the resin components of the hard coat compositions used for preparation of the hard coat films 13 to 18, the evaluation results thereof, and the evaluation results of the hard coat film 1.

TABLE 3

| hard coat film | | | 1 | 13 | 14 | 15 | 16 | 17 | 18 |
|---|---|---|---|---|---|---|---|---|---|
| base film | resin | | PI-1 | PI-1 | PI-1 | PI-1 | PI-1 | PI-1 | PI-1 |
| | thickness (μm) | | 80 | 80 | 80 | 80 | 80 | 80 | 80 |
| HC | siloxane resin | | 100 | 90 | 70 | 50 | 90 | 90 | 90 |
| composition | MEK-EC-2430Z | | — | 10 | 30 | 50 | — | — | — |
| | MEK-EC-2130Y | | — | — | — | — | 10 | — | — |
| | MEK-AC-2140Z | | — | — | — | — | — | 10 | — |
| | PGM-AC-4130Y | | — | — | — | — | — | — | 10 |
| evaluation | cross-cut (%) | | 0 | 0 | 0 | 0 | 0 | 0 | 0 |
| result | mandrel (mm) | | 2 | 2 | 2 | 2 | 2 | 2 | 2 |
| | pencil hardness | | 4H | 6H | 6H | 6H | 6H | 6H | 5H |
| | scratch | 10 | OK | OK | OK | OK | OK | NG | OK |
| | resistance | times | | | | | | | |
| | test | 100 | OK | OK | NG | NG | NG | NG | OK |
| | | times | | | | | | | |

| | | | | | | | |
|---|---|---|---|---|---|---|---|
| haze (%) | 0.2 | 0.4 | 0.3 | 0.2 | 0.4 | 0.3 | 2.5 |
| total light | 90.6 | 90.4 | 90.5 | 90.6 | 90.4 | 90.4 | 90.4 |
| transmittance (%) | | | | | | | |

The hard coat films 13 to 18 in which surface-treated silica particles were added to the hard coat composition were excellent in adhesion of the hard coat layer, and had a higher pencil hardness as compared to the hard coat film 1 obtained using a hard coat composition free of the particles. Among them, the hard coat film 13 containing 10% of silica particles modified with alicyclic epoxy groups was comparable in adhesion, flex resistance, scratch resistance and transparency to the hard coat film 1, and exhibited excellent characteristics.

### DESCRIPTION OF REFERENCE SIGNS

1 Transparent polyimide film
2 Hard coat layer
10 Hard coat film

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A hard coat-equipped polyimide film, comprising:
a transparent polyimide film; and
a hard coat layer formed of a cured product of a hard coat composition;
wherein the transparent polyimide film includes a polyimide having a structure derived from an acid dianhydride and a structure derived from a diamine, and
wherein the hard coat composition comprises a siloxane compound having an alicyclic epoxy group.

2. The hard coat-equipped polyimide film according to claim 1,
wherein the siloxane compound is a condensate of a silane compound containing a compound represented by the following general formula (I):
Y—R¹—(Si(OR²)ₓR³₃₋ₓ) (I)
wherein in the formula (I), Y is an alicyclic epoxy group; R¹ is an alkylene group with 1 to 10 carbon atoms; R² is a hydrogen atom or an alkyl group having 1 to 10 carbon atoms; R³ is a hydrogen atom, or a monovalent hydrocarbon group selected from an alkyl group having 1 to 10 carbon atoms, an aryl group having 6 to 25 carbon atoms, and an aralkyl group having 7 to 12 carbon atoms; and x is an integer of 1 to 3.

3. The hard coat-equipped polyimide film according to claim 1, wherein the siloxane compound in the hard coat composition has a weight average molecular weight of 500 to 20000.

4. The hard coat-equipped polyimide film according to claim 1, wherein the hard coat layer further comprises particles having an average particle diameter of 5 to 1000 nm.

5. The hard coat-equipped polyimide film according to claim 4, wherein the particles are core-shell polymer particles having a rubber polymer core layer and a shell layer provided on a surface of the core layer.

6. The hard coat-equipped polyimide film according to claim 4, wherein the particles have on surfaces thereof a polymerizable functional group capable of reacting with the alicyclic epoxy group of the siloxane compound.

7. The hard coat-equipped polyimide film according to claim 4, wherein the particles and the siloxane compound are crosslinked through a polymerizable functional group on a surface of the particles and the alicyclic epoxy group of the siloxane compound.

8. The hard coat-equipped polyimide film according to claim 1, wherein the hard coat layer further comprises a neutral salt.

9. The hard coat-equipped polyimide film according to claim 1,
wherein a hard coat layer-formed surface of the hard coat-equipped polyimide film has a pencil hardness of 3H or higher,
wherein the hard coat-equipped polyimide film has a total light transmittance of 80% or more, and
wherein the hard coat layer is not cracked when the hard coat-equipped polyimide film is bent along a cylindrical mandrel having a diameter of 5 mm with the hard coat layer-formed surface on an outer side.

10. The hard coat-equipped polyimide film according to claim 1,
wherein the acid dianhydride contains 20 to 65 mol % of an acid dianhydride represented by the general formula (1), and 35 to 80 mol % of a fluorine-containing aromatic acid dianhydride, based on 100 mol % of a total of the acid dianhydride, and 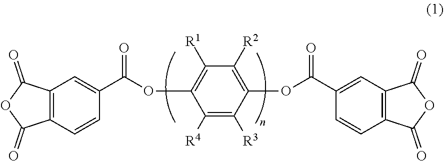
wherein the diamine contains 60 to 80 mol % of a fluoroalkyl-substituted benzidine and 20 to 40 mol % of 3,3′-diaminodiphenylsulfone, based on 100 mol % of a total of the diamine,
wherein, in the general formula (1), n is 1 or 2, and R¹ to R⁴ are each independently a hydrogen atom, an alkyl group having 1 to 20 carbon atoms, or a perfluoroalkyl group having 1 to 20 carbon atoms,

11. The hard coat-equipped polyimide film according to claim 10, wherein the acid dianhydride represented by the general formula (1) includes an acid dianhydride represented by formula (2)

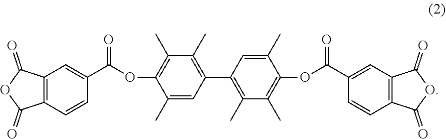

12. The hard coat-equipped polyimide film according to claim 10,
wherein the acid dianhydride represented by the general formula (1) includes an acid dianhydride represented by formula (3), and 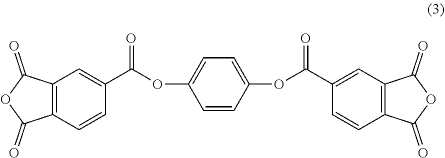
the structure derived from the acid dianhydride in the polyimide further comprises a structure derived from 3,3′,4,4′-biphenyltetracarboxylic acid dianhydride.

13. The hard coat-equipped polyimide film according to claim 10, wherein the fluoroalkyl-substituted benzidine is 2,2′-bis(trifluoromethyl)benzidine.

14. The hard coat-equipped polyimide film according to claim 10,
wherein the fluorine-containing aromatic acid dianhydride is 2,2-bis(3,4-dicarboxyphenyl)-1,1,1,3,3,3-hexafluoropropanoic acid dianhydride.

15. The hard coat-equipped polyimide film according to claim 1,
wherein the acid dianhydride contains 10 to 65 mol % of an acid dianhydride represented by the general formula (1), based on 100 mol % of a total of the acid dianhydride, and
wherein the diamine contains 40 mol % or more of a fluoroalkyl-substituted benzidine, based on 100 mol % of a total of the diamine, 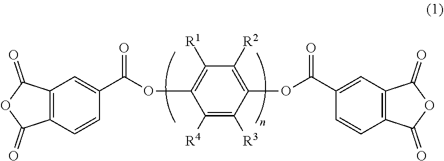
wherein, in the general formula (1), n is 1 or 2, and R¹ to R⁴ are each independently a hydrogen atom, an alkyl group having 1 to 20 carbon atoms, or a perfluoroalkyl group having 1 to 20 carbon atoms.

16. The hard coat-equipped polyimide film according to claim 15, wherein the acid dianhydride represented by the general formula (1) includes an acid dianhydride represented by formula (2)

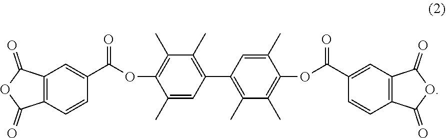

17. The hard coat-equipped polyimide film according to claim 15, wherein the acid dianhydride represented by the general formula (1) includes an acid dianhydride represented by formula (3)

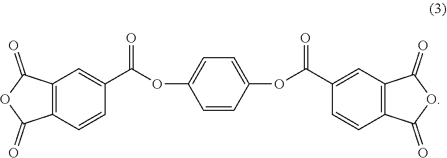

18. The hard coat-equipped polyimide film according to claim 1,
wherein the acid dianhydride contains an alicyclic acid dianhydride and a fluorine-containing aromatic acid,
wherein the diamine contains a fluorine-containing aromatic diamine and 3,3′-diaminodiphenylsulfone,
wherein a total of the alicyclic acid dianhydride and the fluorine-containing aromatic acid is 70 mol % or more, based on 100 mol % of a total of the acid dianhydride, and
wherein a total of the fluorine-containing aromatic diamine and 3,3′-diaminodiphenylsulfone is 70 mol % or more, based on 100 mol % of a total of the diamine.

19. A method for manufacturing the hard coat-equipped polyimide film set forth in claim 1, the method comprising:
applying the hard coat composition onto a principal surface of the transparent polyimide film having a total light transmittance of 80% or more; and
applying an active energy ray to cure the hard coat composition,
wherein the hard coat composition comprises the siloxane compound having the alicyclic epoxy group.

20. An image display device, comprising:
an image display panel; and
the hard coat-equipped polyimide film set forth in claim 1 disposed on a surface of the image display panel.
